(19) United States
(12) Patent Application Publication
(10) Pub. No.: US 2003/0052767 A1
(43) Pub. Date: Mar. 20, 2003

(54) Coil for electrical and electronic equipment as well as process for production thereof

(76) Inventors: Hiroshi Yamanobe, Tokyo (JP); Takaaki Ichikawa, Tokyo (JP); Tsutomu Komori, Tokyo (JP); Hiroaki Komatsu, Tokyo (JP)

Correspondence Address: ANTONELLI, TERRY, STOUT AND KRAUS, LLP, Suite 1800, 1300 North Seventeenth Street, Arlington, VA, 22209, US

(21) Appl. No.: 10/132,714

(22) Filed: Apr. 26, 2002

(30) Foreign Application Priority Data
Sep. 18, 2001 (JP) 2001-282905

(51) Int. Cl. H01F 27/28

(52) U.S. Cl. 336/232

(57) ABSTRACT

A coil for electrical and electronic equipment comprises a spiral conductor coil 2 prepared by disposing coaxially a plurality of conductors 4a through 4d each having a flat circular arc-shaped configuration in multiple stages along a vertical direction, and linking sequentially ends of these conductors 4a through 4d to each other by means of linking members 5a through 5c in the vertical direction; and an insulating layer 3 covering the surface of the conductor coil 2, so that a relationship between a conductor width and a coil core diameter does not depend mutually, it becomes possible to increase and decrease optionally the conductor width and the coil core diameter, and as a result, a wider conductor width and a smaller coil core diameter in the conductor coil 2 than that of a conventional coil can be achieved.

### BACKGROUND OF THE INVENTION

1. Field of the Invention

The present invention relates to a coil for electrical and electronic equipment used for inductance, noise or the like filter as well as a process for the production thereof.

2. Prior Art

Heretofore, a coil produced in accordance with such a manner that a conductor a having a circular or a rectangular section, as shown in FIG. 1 or FIG. 2(b), is worked into a spiral configuration, a surface of the resulting spiralled product is coated with varnish-like polyimide or the like and cured, and then the product thus coated is covered with an insulating material has been principally used as coils for electrical and electronic equipment.

With a recent tendency of high technology in electrical and electronic equipment, a high current-use coil applied to such high-tech electrical and electronic equipment for achieving a short length thereof involves principally a strip-shaped and straight angle conductor a of a section having a wide breadth and a thin thickness, as shown in FIG. 2(b), has been widely used.

Incidentally, when such a straight angle conductor a is adopted and the conductor is made to be a spiral configuration, remarkable flexural strain appears in the conductor a due to a difference between distances on sides of the inner circumference and the outer circumference.

Such flexural strain varies somewhat dependent upon a conductor material. However, flexural strain increases with increase in width of a conductor or decrease in a diameter of a coil that is defined by a distance along the center line of the coil in the cross section thereof extending from a core of the conductor on either side of the coil to another core thereof on the side opposite to the former (see FIG. 2(a)) (hereinafter referred to simply as “coil core diameter”) Due to the fact as described above, there is such a disadvantage that the conductor a is broken at a blast when exceeding a certain limit.

For this reason, when a straight angle conductor a is applied, a geometry of a coil and a width of the conductor should be designed with taking flexural strain at the time of molding the coil into consideration, so that there is a limit of expanding such width of the conductor for downsizing the coil. For instance, when a coil core diameter is 10 (ten) mm in a conductor having 15% breaking extension, around 1.5 mm is a limit for conductor width.

On one hand, in a manner for applying varnish-like polyimide or the like and curing the resulting film, which has been utilized heretofore as a method for forming a covering of an insulator b, a covering thickness of the insulator b becomes extremely thin. so that its insulating strength decreases with increase in width of the conductor a. As a result, it is required to assure a sufficient insulating thickness by repeating plural times of coating operation, or electrode positing an insulating material. However, troublesome operations are required in these manners, so that there is a problem of increase in manufactures' costs.

### SUMMARY OF THE INVENTION

The present invention has been made to solve the problem as described above.

Accordingly, an object of the present invention is to provide a novel coil for electrical and electronic equipment having a wider conductor width and a smaller coil core diameter than that of a conventional coil as well as a novel process for the production thereof by which coils can be produced easily and inexpensively

In order to achieve the above-described objects, a coil for electrical and electronic equipment comprises a spiral conductor coil prepared by disposing coaxially a plurality of conductors each having a flat circular arc-shaped configuration in multiple stages along a vertical direction, and linking sequentially ends of these conductors to each other by means of linking members in the vertical direction; and an insulating layer covering the surface of the conductor coil.

Furthermore, another coil for electrical and electronic equipment comprises a spiral conductor coil prepared by disposing coaxially a plurality of conductors each having a flat polygonal configuration in multiple stages along a vertical direction, and linking sequentially ends of these conductors to each other by means of linking members in the vertical direction; and an insulating layer covering the surface of the conductor coil.

In other words, a coil for electrical and electronic equipment according to the present invention does not relate to a conductive coil unlike a conventional conductive coil, which has been previously prepared by working upon a linear straight angle conductor into a spiral configuration, but utilizes a conductive plate which is prepared by such a manner that metallic plates are pressed or etched to obtain a plurality of flat circular arc-shaped or flat polygonal conductors, ends of these conductors are linked to each other to form a conductive plate, and the respective conductors are alternately folded at linked portions of the respective conductors in the conductive plate so as to coaxially overlap them thereby producing a spiral conductive coil. Hence, no flexural strain is applied to a conductive coil at the time of working upon the same.

As a result, a relationship between a conductor width and a coil core diameter comes to be independent with each other, so that such conductor width and such coil core diameter can be optionally increased or decreased. More specifically, a wider conductor width and a smaller coil core diameter than that of a conventional conductive coil can be achieved in a conductive coil according to the present invention.

In either of the above-described coils for electrical and electronic equipment, the insulating layer may be composed of a pair of plastic films with an adhesive positioned so as to sandwich the conductors in the vertical direction.

In either of the above-described coils for electrical and electronic equipment, the plastic films may be prepared from a material selected from the group consisting of PET (polyethylene terephthalate), PI (polyimide), PEN (polyethylene naphthalate), PPS (polyphenylene sulfide), and PEI (polyether imide).

Moreover, a process for the production of a coil for electrical and electronic equipment according to the present invention comprises the steps of forming a conductor plate prepared by linking sequentially ends of a plurality of conductors each having a flat circular arc-shaped or a polygonal configuration to each other; the plurality of conductors being obtained by pressing or etching metallic plates; covering the surface of the conductor plate with an insulating layer; and then folding alternately the respective conductors at each linked portion of the conductors in the conductor plate so as to overlap coaxially these conductors, thereby forming a substantially spiral conductive coil.

Another process for the production of a coil for electrical and electronic equipment according to the present invention comprises the steps of forming a conductor plate prepared by linking sequentially ends of a plurality of conductors each having a flat circular arc-shaped or a polygonal configuration to each other; the plurality of conductors being obtained by pressing or etching metallic plates; folding alternately the respective conductors at each linked portion of the conductors in the conductor plate so as to overlap coaxially these conductors, thereby forming a substantially spiral conductive coil; and then covering the surface of the conductor plate with an insulating layer.

### BRIEF DESCRIPTION OF THE DRAWINGS

The present invention will be explained in more detail in conjunction with appended drawings, wherein:

FIG. 1 is a plan view showing an example of a conventional coil for electrical and electronic equipment;

FIG. 2(a) is a sectional view taken along the line A-A of FIG. 1;

FIG. 2(b) is a longitudinal sectional view showing an example of a conventional coil for electrical and electronic equipment;

FIG. 3 is a perspective view showing an embodiment of a coil for electrical and electronic equipment according to the present invention;

FIG. 4(a) is a plan view showing the embodiment of the coil for electrical and electronic equipment according to the present invention;

FIG. 4(b) is a sectional view taken along the line A-A of FIG. 4(a);

FIG. 5 is an enlarged sectional view taken along the line B-B of FIG. 4(a);

FIG. 6 is a plan view showing an embodiment of a conductive plate constituting a coil for electrical and electronic equipment according to the present invention; and

FIG. 7 is a perspective view showing a state wherein an insulating layer is formed on the conductive plate of FIG. 6.

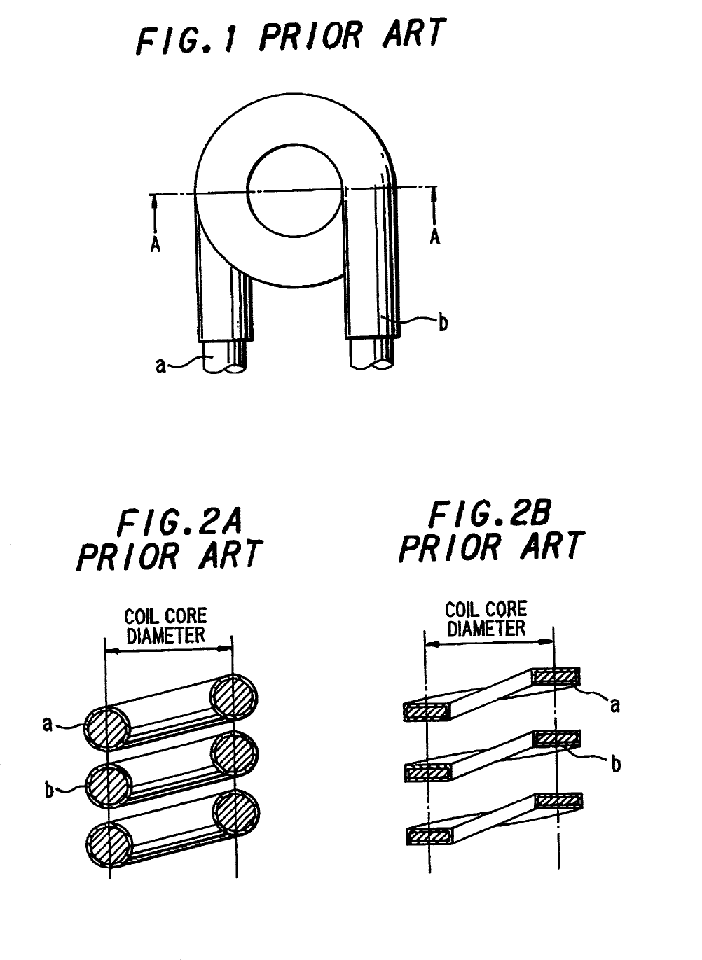

### DESCRIPTION OF THE PREFERRED EMBODIMENTS

In the following, preferred embodiments of the present invention will be described in detail in conjunction with the accompanying drawings.

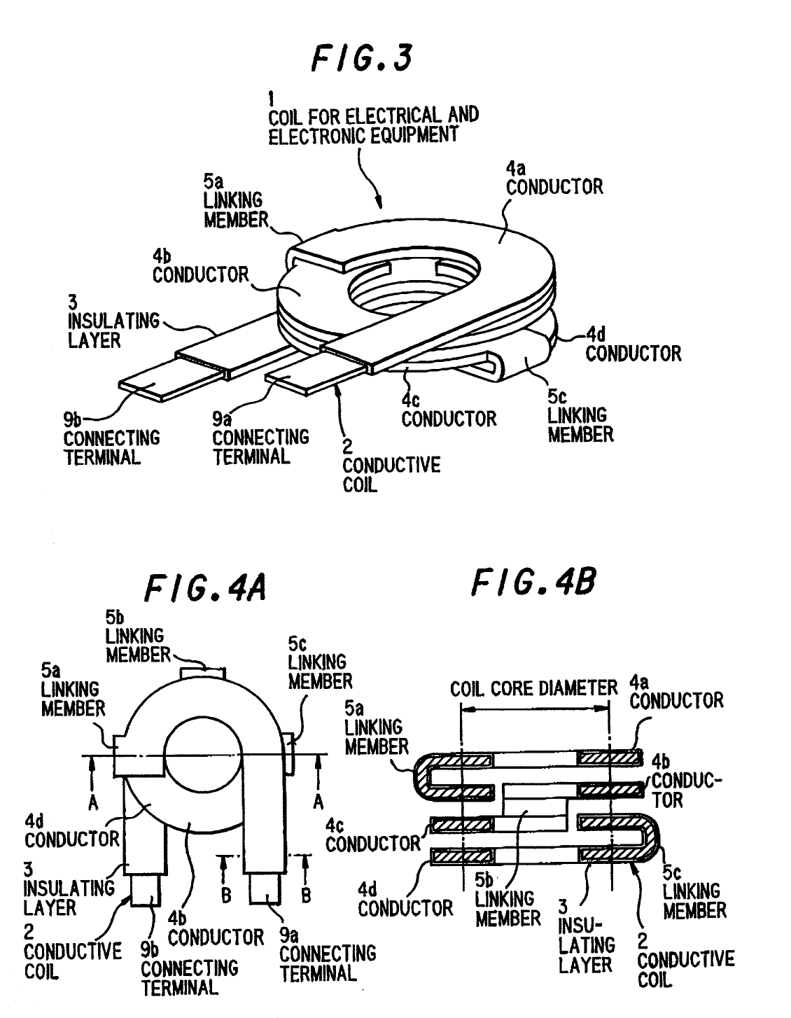

FIG. 3 is a perspective view showing an embodiment of a coil 1 for electrical and electronic equipment according to the present invention, FIG. 4(a) is a plan view of FIG. 3, and FIG. 4(b) is a sectional view taken along the line A-A of FIG. 4(a).

As shown in these figures, the coil 1 for electrical and electronic equipment has a solid construction wherein a surface of a conductive film 2 formed substantially into a spiral configuration is covered and formed with an insulating layer 3.

The conductive coil 2 is prepared by such a manner that four conductors 4a, 4b, 4c, and 4d each being a circular arc-shaped flat plate are superposed coaxially to form multiple stages in a vertical direction with a certain gap, end portions of the conductors adjacent to each other are linked so as to extend vertically by means of conductive linking members 5a, 5b, and 5c, and the respective conductors 4a, 4b, 4c, and 4d are spirally energized from connecting terminals 9a and 9b of the upper and the lower conductor plates 4a and 4d.

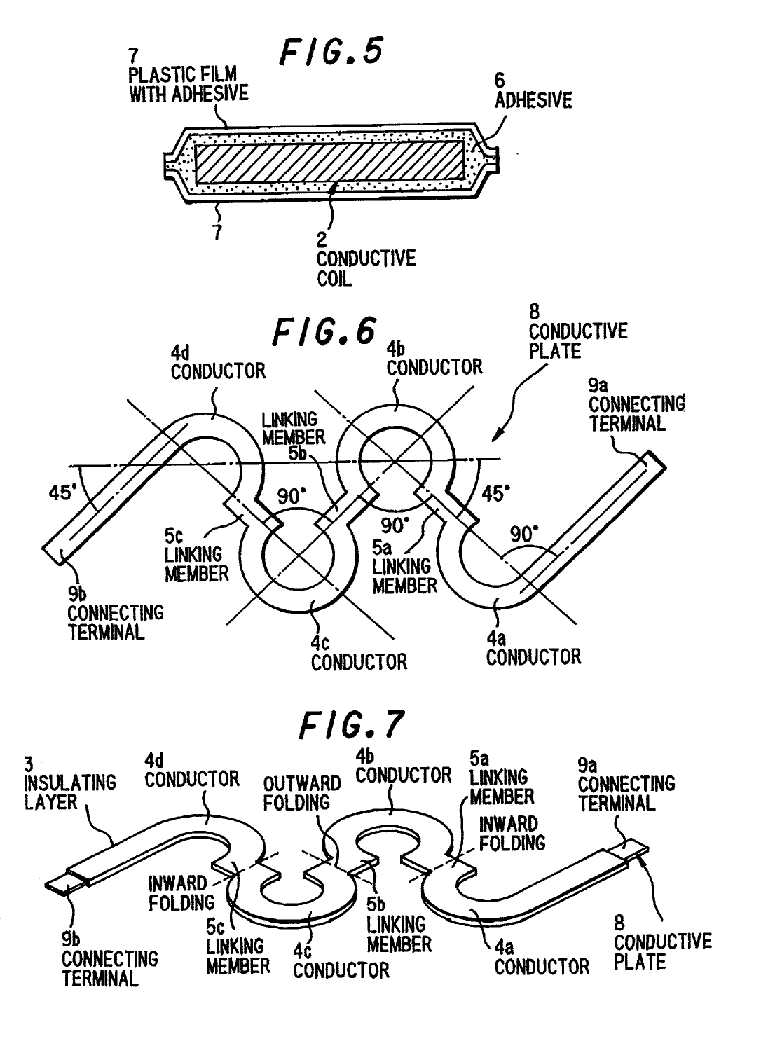

Furthermore, the insulating layer 3 shown in FIG. 7 is composed of a pair of plastic films 7 and 7 wherein an adhesive 6 is applied to a side of each plastic film 7 and arranged in such that the conductor plates 4a through 4d and the linking members 5a through 5c constituting the conductive coil 2 are sandwiched by the pair of plastic films 7 and 7 upwards and downwards to cover the surface of the conductive film 2 as shown in FIG. 5. An example of such plastic films includes well-known plastic materials such as PET (polyethylene terephthalate), PI (polyimide), PEN (polyethylene naphthalate), PPS (polyphenylene sulfide), and PEI (polyether imide).

For preparing the coil 1 for electrical and electronic equipment, first, a flat plate-like conductor plate 8, which is as if the one formed from a plurality of rings by serially linking them to each other, is prepared as shown in FIG. 6. In other words, the conductor plate 8 is prepared by respective end portions of the above-mentioned four flat plate-like circular arc conductors 4a, 4b, 4c, and 4d are linked sequentially to each other by means of the linking members 5a, 5b, and 5c, and such conductor plate may be obtained by pressing or etching a conductive metal sheet.

A constitution of the conductor plate 8 will be described in more detail.

The first conductor 4d positioned at the lowest part in FIG. 3 is disposed along a line extending at an angle of 45° with respect to a horizontal line in FIG. 6 so as to configure a U-shape directing to the left lower oblique part of the figure, the outside end of the conductor 4d extends to be used as a connecting terminal 9b, and the other inside end of the conductor 4d is linked to the second conductor 4c through the linking member 5c. The second conductor 4c is configure in a C-shape, i.e., the upper part of a circular shape of the conductor 4c has been notched in FIG. 6, and the other end of the conductor 4c is linked to the third conductor 4b through the linking member 5b disposed at an angle of 90° with respect to the linking member 5c. The conductor 4b is also configured in a C-shape, i.e., the lower part of a circular shape of the conductor 4b has been notched in FIG. 6 so as to be diphycercal with respect to the conductor 4c, and the other end of the conductor 4b is linked to the fourth conductor 4a through the linking member Sa disposed at an angle of 90° with respect to the linking member 5b. The conductor 4a is disposed along a line extending at an angle of 45° with respect to the horizontal line in FIG. 6 so as to configure a U-shape directing to the right upper oblique part of the figure, which is symmetrical with respect to the conductor 4d, the outside end of the conductor 4a extends to be used as the other connecting terminal 9a, and the other inside end of the conductor 4a is linked to the linking member 5a.

After the conductor plate 8 composed of four linked conductors 4a, 4b, 4c, and 4d each having a flat plate circular arc shape was obtained as described above, the insulating layer 3 is formed by covering the surface of the conductor plate 8 except for the connecting terminals 9a and 9b by means of the above-described plastic films 7 and 7 with an adhesive so as to sandwich the conductor plate 8 from both the upper and the lower directions as shown in FIG. 7. Furthermore, it is desirable to have prepared the plastic films 7 and 7 with an adhesive so as to have a wider width of each of them than a width of the conductor plate 8 and to accord a configuration thereof with that of the conductor plate 8.

Thereafter, as shown in FIG. 7, for example, a portion of the linking member 5c is folded inwards with respect to the conductor plate 8 to overlap coaxially the conductors 4d and 4c with each other, then, the linking member 5b is folded outwards to overlap coaxially the conductor 4b adjacent to the conductor 4c thereon, and further, the linking member 5a is folded inwards to overlap coaxially the fourth conductor 4a on the conductor 4b, whereby the coil 1 for electrical and electronic equipment as shown in FIG. 3 can be easily obtained. In the case where varnish-like polyimide or the like is used for the insulating layer 3, and the resulting conductor plate 8 is processed immediately into a spiral configuration to obtain a coil body 2, conventional applying methods such as a method for immersing the coil body 2 into a container containing varnish-like polyimide or the like, and curing the same; and a method for applying an insulating material by means of electrodeposition, which is expensive, though, may be utilized.

In the coil 1 for electric and electronic equipment according to the present invention thus obtained, no flexural strain is applied to a conductor part unlike a conventional coil composed of a straight angle conductor. As a result, a coil diameter can be arbitrarily reduced irrespective of a conductor width, while it becomes possible to arbitrarily broaden a conductor width irrespective of its coil diameter. Accordingly, it achieves easily to reduce a diameter of a coil and to broaden a width of a conductor that were impossible in a conventional structure of coil, whereby it becomes possible to obtain a high-performance coil, which has a small diameter and is compact, and through which high current can be easily passed. Moreover, since the insulating layer 3 is composed of a pair of plastic films 7 and 7 with an adhesive, a sufficient insulating thickness can be assured in comparison with a conventional insulating method wherein varnish-like polyimide or the like is used, so that positive insulating performance can be brought out.

### EXAMPLE

In accordance with the constitution as described above, a material conductor of OFC (oxygen free high conductivity copper) having 15% breaking extension was used as a conductor plate 8, and a conductor coil 2 having 4 mm conductor width, 0.5 mm thickness, 2.5 turn, and 10 mm coil core diameter was formed. An insulating layer 3 composed of a PI film with an epoxy adhesive (25 μm PI thickness, and 30 μm epoxy adhesive thickness) was applied to the surface of the conductor coil 2 to prepare a coil 1. The resulting coil 1 was subjected to a variety of reliability tests required for usual coils for electrical and electronic equipment such as those of dielectric strength, heat resistance, and flame resistance. As a result, it was proved that various characteristic properties were practically good in the coil 1 according to the present invention without accompanying any trouble. In this connection, when a coil having the same size as that containing a conductor of 15% breaking extension was prepared in accordance with a conventional winding manner, flexural strain became 40% so that production thereof was difficult.

On one hand, it was confirmed that a cost could be reduced by 20% or more in a coil 1 according to the present invention as compared with a conventional manner for applying an insulating material by means of electrodeposition.

In the above-described embodiment, although an example wherein four circular arc-shaped conductors are used has been described, the number of conductors are not limited to four, but more or less number of coils may be used optionally dependent on a desired coil dimension and the like, and as a result, the same effects as that of the above embodiment can be achieved as a matter of course. Furthermore, a configuration of the conductor is not limited to such circular arc shape, but a polygonal shape other than a triangular shape is also applicable. Besides, either of a pair of the plastic films 7 and 7 with an adhesive used for an insulating layer 3 may be replaced by a resist ink.

In brief, since no flexural strain is applied to a conductor part in a coil according to the present invention, reduction in diameter as well as increase in width of a coil, which have not been achieved according to a conventional structure of coil, become possible. As a result, the invention exhibits such an excellent advantage that a high-performance coil, which is small-sized and compact, and through which high current may be easily passed can be inexpensively produced.

The presently disclosed embodiments are therefore considered in all respects to be illustrative and not restrictive. The scope of the invention is indicated by the appended claims rather than the foregoing description, and all changes that come within the meaning and range of equivalents thereof are intended to be embraced therein.

What is claimed is:

1. A coil for electrical and electronic equipment, comprising:
a spiral conductor coil prepared by disposing coaxially a plurality of conductors each having a flat circular arc-shaped configuration in multiple stages along a vertical direction, and linking sequentially ends of said conductors to each other by means of linking members in the vertical direction; and
an insulating layer covering the surface of said conductor coil.

2. A coil for electrical and electronic equipment, comprising:
a spiral conductor coil prepared by disposing coaxially a plurality of conductors each having a flat polygonal configuration in multiple stages along a vertical direction, and linking sequentially ends of said conductors to each other by means of linking members in the vertical direction; and
an insulating layer covering the surface of said conductor coil.

3. A coil for electrical and electronic equipment as claimed in claim 1, wherein:
said insulating layer is composed of a pair of plastic films with an adhesive positioned so as to sandwich said conductors in the vertical direction.

4. A coil for electrical and electronic equipment as claimed in claim 2, wherein:
said insulating layer is composed of a pair of plastic films with an adhesive positioned so as to sandwich said conductors in the vertical direction.

5. A coil for electrical and electronic equipment as claimed in claim 1, wherein:
said plastic films are prepared from a material selected from the group consisting of PBT (polyethylene terephthalate), PI (polyimide), PEN (polyethylene naphthalate), PPS (polyphenylene sulfide), and PEI (polyether imide).

6. A coil for electrical and electronic equipment as claimed in claim 2, wherein:
said plastic films are prepared from a material selected from the group consisting of PBT (polyethylene terephthalate), PI (polyimide), PEN (polyethylene naphthalate), PPS (polyphenylene sulfide), and PEI (polyether imide).

7. A process for the production of a coil for electrical and electronic equipment, comprising the steps of:
forming a conductor plate prepared by linking sequentially ends of a plurality of conductors each having a flat circular arc-shaped or a polygonal configuration to each other;
said plurality of conductors being obtained by pressing or etching metallic plates;
covering the surf ace of said conductor plate with an insulating layer; and then
folding alternately said respective conductors at each linked portion of said conductors in said conductor plate so as to overlap coaxially said conductors thereby forming a substantially spiral conductive coil.

8. A process for the production of a coil for electrical and electronic equipment, comprising the steps of;
forming a conductor plate prepared by linking sequentially ends of a plurality of conductors each having a flat circular arc-shaped or a polygonal configuration to each other;
said plurality of conductors being obtained by pressing or etching metallic plates;
folding alternately said respective conductors at each linked portion of said conductors in said conductor plate so as to overlap coaxially said conductors thereby forming a substantially spiral conductive coil; and then
covering the surface of said conductor plate with an insulating layer.
